(19) United States
(12) Patent Application Publication
(10) Pub. No.: US 2022/0035154 A1
(43) Pub. Date: Feb. 3, 2022

(54) ANIMATION PRODUCTION SYSTEM

(71) Applicant: AniCast RM Inc., Minato-ku (JP)

(72) Inventors: Yoshihito KONDOH, Chuo-ku (JP); Masato MUROHASHI, Tokyo (JP)

(21) Appl. No.: 17/008,137

(22) Filed: Aug. 31, 2020

(30) Foreign Application Priority Data
Jul. 29, 2020 (JP) 2020-128300

(51) Int. Cl. G02B 27/00; G06F 3/01; G02B 27/01

(52) U.S. Cl. CPC G02B 27/0093; G02B 2027/0187; G02B 27/017; G06F 3/013

(57) ABSTRACT

To enable you to take animations in a virtual space, an animation production system comprising: a virtual camera located in a virtual space; a user input detection unit that detects an input of a user from at least one of a head mounted display and a controller which the user mounts; a character control unit that controls a character disposed in the virtual space in response to the input; a gaze acquiring unit that acquires a gaze of the user; and an operation target switching unit that switches the character to be operated by the user in accordance with the gaze.

### TECHNICAL FIELD

The present invention relates to an animation production system.

### BACKGROUND ART

Virtual cameras are arranged in a virtual space (see Patent Document 1).

### CITATION LIST

### Patent Literature

[PTL 1] Patent Application Publication No. 2017-146651

### SUMMARY OF INVENTION

### Technical Problem

No attempt was made to capture animations in the virtual space.

The present invention has been made in view of such a background, and is intended to provide a technology capable of capturing animations in a virtual space.

### Solution to Problem

The principal invention for solving the above-described problem is an animation production system comprising: a virtual camera located in a virtual space; a user input detection unit that detects an input of a user from at least one of a head mounted display and a controller which the user mounts; a character control unit that controls a character disposed in the virtual space in response to the input; a gaze acquiring unit that acquires a gaze of the user; and an operation target switching unit that switches the character to be operated by the user in accordance with the gaze.

The other problems disclosed in the present application and the method for solving them are clarified in the sections and drawings of the embodiments of the invention.

### Advantageous Effects of Invention

According to the present invention, animations can be captured in a virtual space.

### BRIEF DESCRIPTION OF DRAWINGS

FIG. 1 is a diagram illustrating an example of a virtual space displayed on a head mount display (HMD) mounted by a user in an animation production system 300 of the present embodiment.

FIG. 2 is a diagram illustrating an example of the overall configuration of an animation production system 300 according to an embodiment of the present invention.

FIG. 3 is a diagram schematically illustrating the appearance of the HMD 110 according to the present embodiment.

FIG. 4 is a diagram illustrating an example of a functional configuration of the HMD 110 according to the present embodiment;

FIG. 5 is a diagram schematically illustrating the appearance of the controller 210 according to the present embodiment.

FIG. 6 is a diagram illustrating an example of a functional configuration of a controller 210 according to the present embodiment;

FIG. 7 is a diagram illustrating a functional configuration of an image producing device 310 according to the present embodiment;

FIG. 8 is a diagram illustrating an operation of a camera 3 in an animation production system 300 according to the present embodiment;

FIG. 9 is a diagram illustrating the operation of the possessing target switching unit 480 of the animation production system 300 according to the present embodiment;

### DESCRIPTION OF EMBODIMENTS

The contents of embodiments of the present invention will be described with reference. The present invention includes, for example, the following configurations.

### Item 1

An animation production system comprising:

a virtual camera located in a virtual space;

a user input detection unit that detects an input of a user from at least one of a head mounted display and a controller which the user mounts;

a character control unit that controls a character disposed in the virtual space in response to the input;

a gaze acquiring unit that acquires a gaze of the user; and

an operation target switching unit that switches the character to be operated by the user in accordance with the gaze.

### Item 2

The animation production system according to claim 1, wherein

the operation target switching unit switches the operation target to the character where the gaze overlaps for a predetermined period of time.

### Item 3

The animation production system according to claim 1, wherein

the gaze acquiring unit acquires the gazes of both eyes of the user,

the system further comprising a focus acquiring unit that determines a focus of the user based on the gazes, and

the operation target switching unit switches the operation target to the character where the focus overlaps for a predetermined period.

A specific example of an animation production system 300 according to an embodiment of the present invention will be described below with reference to the drawings. It should be noted that the present invention is not limited to these examples, and is intended to include all modifications within the meaning and scope of equivalence with the appended claims, as indicated by the appended claims. In the following description, the same elements are denoted by the same reference numerals in the description of the drawings and overlapping descriptions are omitted.

### Overview

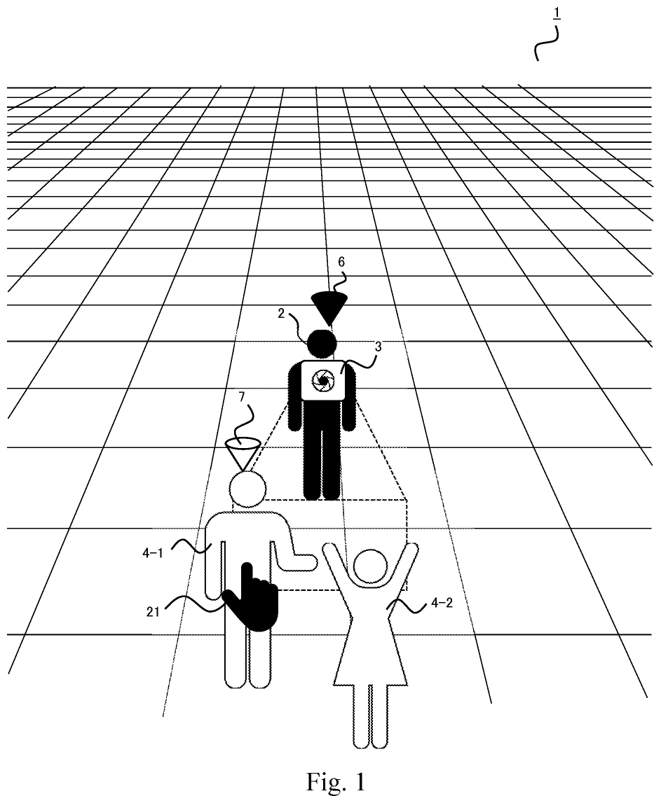

FIG. 1 is a diagram illustrating an example of a virtual space displayed on a head mount display (HMD) mounted by a user in an animation production system 300 according to the present embodiment. The animation production system 300 according to the present exemplary embodiment is intended to create an animation by placing a virtual character 4 and a virtual camera 3 in a virtual space 1 and taking a character 4 using a camera 3.

A photographer 2 (a photographer character) is disposed in the virtual space 1, and the camera 3 is virtually operated by the photographer 2. In the animation production system 300 of this embodiment, as shown in FIG. 1, the user arranges the character 4 and the camera 3 while viewing the virtual space 1 from a bird's eye (Third Person's View), shoots the character 4 using the FPV (First Person View) as the photographer 2, and performs the performance of the character 4 using the FPV, while producing the animation. A plurality of characters 4 (in the example of FIG. 1, characters 4-1 and 4-2) can be disposed within the virtual space 1, and the user can perform the performance while possessing the selected character 4 (setting the operation target). When a plurality of characters 4 are disposed, the user can switch the possessed object (the object to be operated) to one of the characters 4 (e.g., characters 4-1 and 4-2).

In this manner, in the animation production system 300 of the present embodiment, one can play a number of roles (roles). In addition, since the camera 2 can be virtually operated as the photographer 2, natural camera work can be realized and the representation of the movie to be shot can be enriched.

### General Configuration

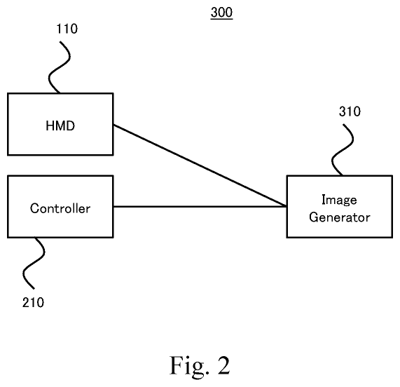

FIG. 2 is a diagram illustrating an example of the overall configuration of an animation production system 300 according to an embodiment of the present invention. The animation production system 300 may comprise, for example, an HMD 110, a controller 210, and an image generating device 310 that functions as a host computer. An infrared camera (not shown) or the like can also be added to the animation production system 300 for detecting the position, orientation and slope of the HMD 110 or controller 210. These devices may be connected to each other by wired or wireless means. For example, each device may be equipped with a USB port to establish communication by cable connection, or communication may be established by wired or wireless, such as HDMI, wired LAN, infrared, Bluetooth™, WiFi™. The image generating device 310 may be a PC, a game machine, a portable communication terminal, or any other device having a calculation processing function.

### HMD110

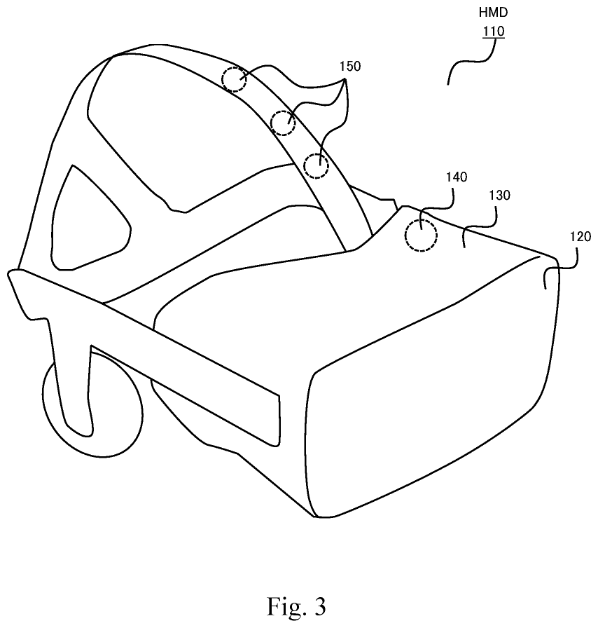

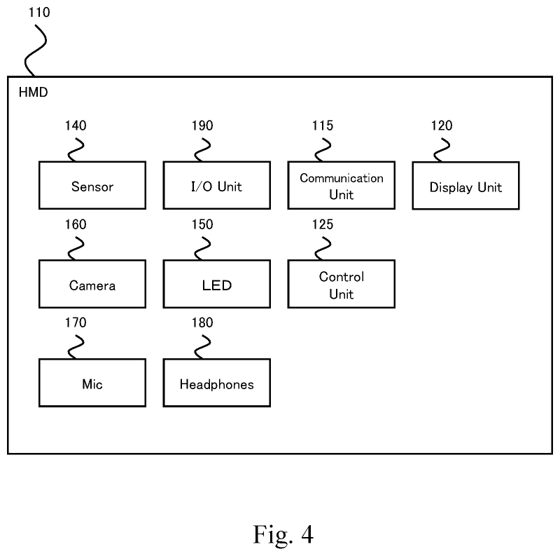

FIG. 3 is a diagram schematically illustrating the appearance of the HMD 110 according to the present embodiment. FIG. 4 is a diagram illustrating an example of a functional configuration of the HMD 110 according to the present embodiment.

The HMD 110 is mounted on the user's head and includes a display panel 120 for placement in front of the user's left and right eyes. Although the display panel 120 may be an optically transmissive or non-transmissive display, the present embodiment illustrates a non-transmissive display panel that can provide more immersion. The display panel 120 displays a left-eye image and a right-eye image, which can provide the user with a three-dimensional image by utilizing the visual difference of both eyes. If left- and right-eye images can be displayed, a left-eye display and a right-eye display can be provided separately, and an integrated display for left-eye and right-eye can be provided.

The housing portion 130 of the HMD 110 includes a sensor 140. Sensor 140 may comprise, for example, a magnetic sensor, an acceleration sensor, or a gyro sensor, or a combination thereof, to detect movements such as the orientation or tilt of the user's head. When the vertical direction of the user's head is Y-axis, the axis corresponding to the user's anteroposterior direction is Z-axis, which connects the center of the display panel 120 with the user, and the axis corresponding to the user's left and right direction is X-axis, the sensor 140 can detect the rotation angle around the X-axis (so-called pitch angle), rotation angle around the Y-axis (so-called yaw angle), and rotation angle around the Z-axis (so-called roll angle).

In place of or in addition to the sensor 140, the housing portion 130 of the HMD 110 may also include a plurality of light sources 150 (e.g., infrared light LEDs, visible light LEDs). A camera (e.g., an infrared light camera, a visible light camera) installed outside the HMD 110 (e.g., indoor, etc.) can detect the position, orientation, and tilt of the HMD 110 in a particular space by detecting these light sources. Alternatively, for the same purpose, the HMD 110 may be provided with a camera for detecting a light source installed in the housing portion 130 of the HMD 110.

The housing portion 130 of the HMD 110 may also include an eye tracking sensor. The eye tracking sensor is used to detect the user's left and right eye gaze directions and gaze. There are various types of eye tracking sensors. For example, the position of reflected light on the cornea, which can be irradiated with infrared light that is weak in the left eye and right eye, is used as a reference point, the position of the pupil relative to the position of reflected light is used to detect the direction of the eye line, and the intersection point in the direction of the eye line in the left eye and right eye is used as a focus point.

### Controller 210

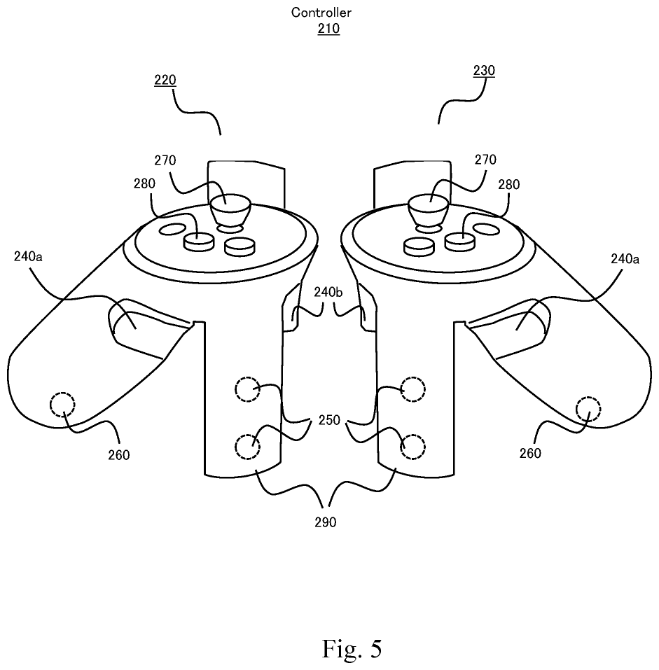

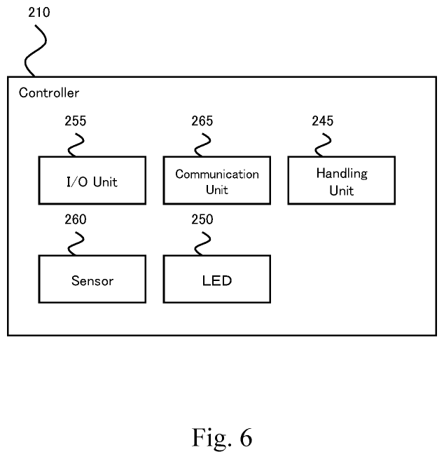

FIG. 5 is a diagram schematically illustrating the appearance of the controller 210 according to the present embodiment. FIG. 6 is a diagram illustrating an example of a functional configuration of a controller 210 according to this embodiment.

The controller 210 can support the user to make predetermined inputs in the virtual space. The controller 210 may be configured as a set of left-hand 220 and right-hand 230 controllers. The left hand controller 220 and the right hand controller 230 may each have an operational trigger button 240, an infrared LED 250, a sensor 260, a joystick 270, and a menu button 280.

The operation trigger button 240 is positioned as 240a, 240b in a position that is intended to perform an operation to pull the trigger with the middle finger and index finger when gripping the grip 235 of the controller 210. The frame 245 formed in a ring-like fashion downward from both sides of the controller 210 is provided with a plurality of infrared LEDs 250, and a camera (not shown) provided outside the controller can detect the position, orientation and slope of the controller 210 in a particular space by detecting the position of these infrared LEDs.

The controller 210 may also incorporate a sensor 260 to detect movements such as the orientation and tilt of the controller 210. As sensor 260, it may comprise, for example, a magnetic sensor, an acceleration sensor, or a gyro sensor, or a combination thereof. Additionally, the top surface of the controller 210 may include a joystick 270 and a menu button 280. It is envisioned that the joystick 270 may be moved in a 360 degree direction centered on the reference point and operated with a thumb when gripping the grip 235 of the controller 210. Menu buttons 280 are also assumed to be operated with the thumb. In addition, the controller 210 may include a vibrator (not shown) for providing vibration to the hand of the user operating the controller 210. The controller 210 includes an input/output unit and a communication unit for outputting information such as the position, orientation, and slope of the controller 210 via a button or a joystick, and for receiving information from the host computer.

With or without the user grasping the controller 210 and manipulating the various buttons and joysticks, and with information detected by the infrared LEDs and sensors, the system can determine the movement and attitude of the user's hand, pseudo-displaying and operating the user's hand in the virtual space.

### Image Generator 310

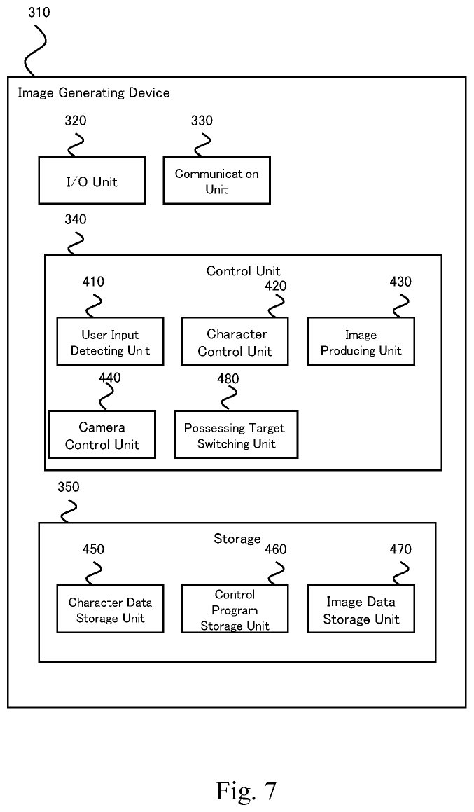

FIG. 7 is a diagram illustrating a functional configuration of an image producing device 310 according to the present embodiment. The image producing device 310 may use a device such as a PC, a game machine, a portable communication terminal, or the like, which has a function for storing information on the user's head movement or the movement or operation of the controller acquired by the user input information or the sensor, which is transmitted from the HMD 110 or the controller 210, performing a predetermined computational processing, and generating an image. The image producing device 310 may include an input/output unit 320 for establishing a wired connection with a peripheral device such as, for example, an HMD 110 or a controller 210, and a communication unit 330 for establishing a wireless connection such as infrared, Bluetooth, or WiFi (registered trademark). The information received from the HMD 110 and/or the controller 210 regarding the movement of the user's head or the movement or operation of the controller is detected in the control unit 340 as input content including the operation of the user's position, line of sight, attitude, speech, operation, etc. through the I/O unit 320 and/or the communication unit 330, and a control program stored in the storage unit 350 is executed in accordance with the user's input content to perform a process such as controlling the character 4 and generating an image. The control unit 340 may be composed of a CPU. However, by further providing a GPU specialized for image processing, information processing and image processing can be distributed and overall processing efficiency can be improved. The image generating device 310 may also communicate with other computing processing devices to allow other computing processing devices to share information processing and image processing.

The control unit 340 includes a user input detecting unit 410 that detects information received from the HMD 110 and/or the controller 210 regarding the movement of the user's head, the user's speech, and the movement and operation of the controller, a character control unit 420 that executes a control program stored in the control program storage unit 460 for a character 4 stored in the character data storage unit 450 of the storage unit 350, a camera control unit 440 that controls a virtual camera 3 disposed in the virtual space 1 in accordance with the character control, a possessing object switching unit 480 that switches the possessing object (the object to be operated), and an image producing unit 430 that generates an image in which the camera 3 captures the virtual space 1 based on the character control. Here, the movement of the character 4 or the camera man 2 is controlled by converting information such as the direction, inclination, and hand movement of the user head detected through the HMD 110 or the controller 210 into the movement of each part of the bone structure created in accordance with the movement or restriction of the joints of the human body, and applying the bone structure movement to the previously stored character data. The control of the camera 3 is performed, for example, by changing various settings (e.g., the position within the virtual space 1 of the camera 3, the shooting direction, the focus position, and the zoom of the camera 3) with respect to the camera 3 according to the movement of the character 4 by hand.

The storage unit 350 stores in the aforementioned character data storage unit 450 information related to the character 4, such as the attribute of the character 4, as well as the image data of the character 4. The control program storage unit 460 controls the operation and expression of the character 4 in the virtual space and stores a program for controlling an object such as the camera 3. The image data storage unit 470 stores the image generated by the image producing unit 430.

### Camera Operation

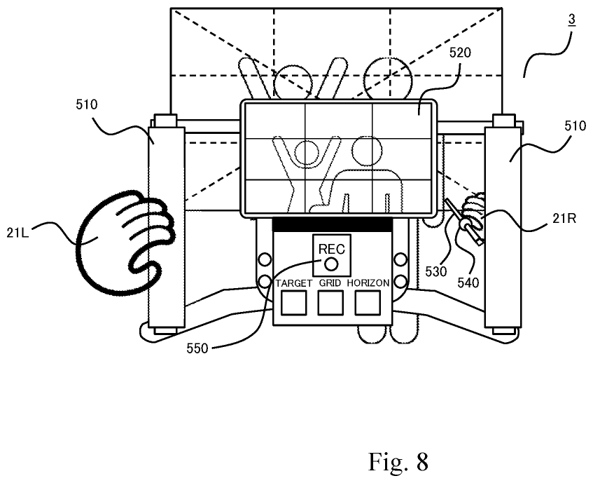

FIG. 8 is a diagram illustrating the operation of the camera 3 by the camera man 2 in the animation production system 300 according to the present embodiment. In FIG. 8, it is assumed that the user's possession target (to be operated) is set to Cameraman 2.

Each of the cameras 3 is provided with a handle 510 on both sides. The character control unit 420 (which may be the camera control unit 440; the same shall apply hereinafter) controls the movement of the camera man 2 by hand 21 in response to an input from the controller 210. For example, the position of the hand 21 is controlled in response to the position of the controller 210 and the grasping action of the hand 21 is controlled in response to the pushing of the trigger button 240. When the user's hand 21 grips the handle 510, the camera control unit 440 changes the position, posture (shooting direction), and focus position of the camera 3 according to the movement of the hand 21. The image displayed on the display unit 510 changes depending on the position, position, and focal position of the camera 3. That is, in the virtual space 1, the user can implement the camera work of the camera 3 by operating the controller 210. Since the user can operate the camera 3 with both hands, it is possible to perform the same camera work operation as the actual professional camera. In addition, the camera control unit 440 can perform a so-called image stabilization process in order to suppress shaking associated with the operation of the virtual camera 3 by the cameraman 2 possessed by the user. For example, the camera control unit 440 can record an image that enters the image angle (captured area) of the camera 3 in a buffer, calculate the movement amount by comparing the image (entered in the image angle) taken at the time of recording with the image (entered in the image angle) taken at the time of recording, or can detect a change in the attitude (the photographing direction) of the camera 3 by operation, calculate the movement amount of the shooting area according to the change in the attitude, and perform image stabilization by shifting the image angle (the photographed area) according to the calculated movement amount.

A display unit 520 is provided in the camera 3. In the display unit 520, an image captured by the camera 3 in the virtual space 1 is displayed. The user can operate the camera 3 while checking the image displayed on the display unit 520. That is, the photographer 2 can operate the camera 3 in the virtual space 1 without any actual camera work. In the vicinity of the display unit 520, a recording button 550 is disposed. When a recording button 550 is pressed, the image producing unit 430 records the image taken by the camera 3 as a moving image in the image data storage unit 470. When the recording button 550 is pressed again, the recording by the image producing unit 430 ends.

A slider 540 is also disposed on the camera 3. The user may move the hand 21 to grasp the slider 540 and move the slider 540 along the rail 530. In this embodiment, the race 530 is provided between the camera 3 and the subject to be shot (e.g., the character 4) and extends parallel to the anteroposterior direction (a direction parallel to the shooting direction of the camera 3 in which the shooting direction of the camera 3 is forward). The camera control unit 440 may adjust the zoom of the camera 3 in response to movement of the slider 540. For example, when the camera control unit 440 is moved so that the slider 540 is closer to the shooting object (in the shooting direction of the camera 3), the magnification ratio of the zoom of the camera 3 can be increased, and when the slider 540 is moved so that the slider 540 is closer to the camera 3 (in the direction opposite to the shooting direction of the camera 3), the magnification ratio of the zoom of the camera 3 can be reduced. The direction in which the slider 540 moves (the longitudinal direction of the rail 530) may not be parallel to the photographing direction of the camera, for example, the vertical direction or the left-right direction. The slider 540 may also be a rotational or spiral action instead of a linear operation.

The zooming of the camera 3 may be performed in response to the manual operation of the slider 540 by the user, as well as, for example, automatically changing the zoom so that the zoom changes at a constant speed. In this case, the control section 340 may include an automatic control section of the camera 3. For example, the automatic control unit may accept the designation of the zoom at start and the zoom at end and change the zoom rate (zoom in or out) from the zoom at start to the zoom at end by a specified time in response to a user's instruction to start. The automatic control unit may also, for example, zoom in or out to a predetermined degree while an external device (such as a switch or keyboard of controller 210) is pressed.

Similarly, the automatic control may be adapted to provide a pan, tilt, track, or lead of the camera 3. That is, while the external device is being pressed, the camera 3 can be rotated (pan) in the left and right directions, rotated (tilt) in the up and down directions, and the camera 3 can be moved in parallel (track), especially the camera 3 can be moved (lead) in parallel toward the subject (character 4).

In addition, the image stabilizer function can be virtually provided in the camera 3. The image stabilizer function may, for example, provide a virtual stabilizer on the camera 3, or it may analyze the image taken by the camera 3 to obtain, for example, the image shake direction and the degree of shake of the image, and to shift the image in the acquired direction and degree so as to obtain the correction effect.

### Operation

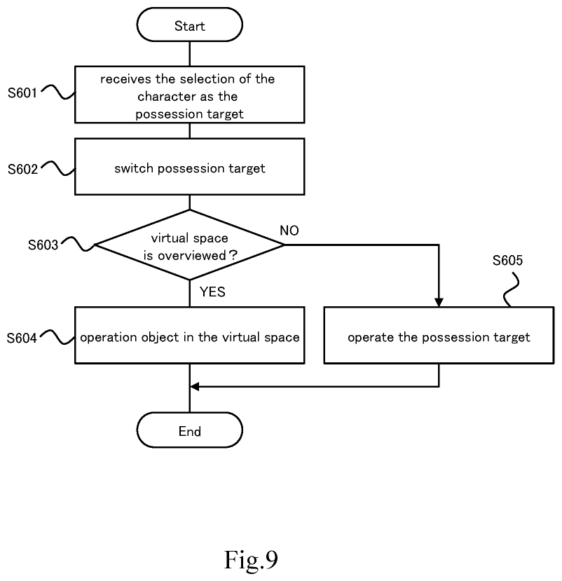

FIG. 9 is a diagram illustrating the operation of the possessing target switching unit 480 of the animation production system 300 according to the present embodiment.

The possession target switching unit 480 receives the selection of the character 4 as the possession target (operation target) (S601). When the trigger button 240 is pulled, for example, when a character 4 is represented by a movement of a finger 21 and a finger 21 is represented by a character 4 in a state in which a bird's eye view of the virtual space 1 is taken as shown in FIG. 1, the possession target switching unit 480 can determine that the character 4 indicated by the finger 21 is selected. When the character 4 is selected, the possession target switching unit 480 sets the selected character 4 as the possession target from the user (S602).

When the virtual space 1 is overviewed as shown in FIG. 1 (S603: YES), the operation of the user controller 210 or the HMD 110 is not reflected in the operation of the character 4, and various object operations of two or three dimensions are performed in the virtual space 1 (S604). The operation of an object in virtual space 1 includes, for example, arranging a new character 4, changing the position of the character 4, selecting the character 4 to be possessed, arranging a new camera 3, changing the position or the shooting direction of the camera 3, arranging a new background image, changing the position or size of the background image, arranging a new light source (not shown), moving a light source position, changing the position of a new wind source (not shown), changing the position of the wind source, changing the direction of the wind blowing from the wind source, turning the switch on and off for the start or end of the wind blow from the wind source, setting texture on the character 4, and attaching an accessory to the character 4.

On the other hand, when the birds-eye view mode is not selected (S603: NO), the object possessed by the user is operated (S605). For example, when the character 4 is possessed, the character control unit 420 controls the operation of the character 4 according to the operation of the user controller 210 or the HMD 110 (S605). By manipulating the character 4, various two- or three-dimensional objects can be grasped and moved by the hand of the character 4, or an accessory can be mounted. In addition, with regard to a specific object (which can be specified by the user), such as a background image, it is possible to prevent the character 4 from being grasped and moved during possession of the character 4. This may, for example, prevent the background from being misgrasped and moved during the performance of character 4.

As described above, according to the animation production system 300 of the present exemplary embodiment, a user can operate the camera 3 as the camera man 2 in the virtual space 1 to take video images. Accordingly, since the camera 3 can be operated in the same way as in the real world to take photographs, it is possible to realize a natural camera work and to provide a richer representation of the animated video.

Further, according to the animation production system 300 of the present embodiment, the character 4 can be performed sequentially while switching the character 4 to be possessed in the virtual space 1. Thus, animation can be efficiently captured.

Although the present embodiment has been described above, the above-described embodiment is intended to facilitate the understanding of the present invention and is not intended to be a limiting interpretation of the present invention. The present invention may be modified and improved without departing from the spirit thereof, and the present invention also includes its equivalent.

For example, in the present embodiment, the image generating device 310 may be a single computer, but not limited to the HMD 110 or the controller 210 may be provided with all or some of the functions of the image generating device 310. It may also include a function of a portion of the image generating device 310 to other computers that are communicatively connected with the image generating device 310.

In the present exemplary embodiment, a virtual space based on the virtual reality (VR; Virtual Reality) was assumed. However, the animation production system 300 of the present exemplary embodiment is not limited to an extended reality (AR; Augmented Reality) space or a complex reality (MR; Mixed Reality) space, but the animation production system 300 of the present exemplary embodiment is still applicable.

Further, in the present embodiment, an explanation of the switching process of the mode that overviews the virtual space 1 and the mode that operates the character 4 is omitted. However, the switching of these modes can be realized by any method. For example, a button to switch the mode in the virtual space 1 can be arranged, and the mode can be switched according to the operation of the controller 210, such as by selecting a button or a tap. For example, the mode may be switched depending on the trigger button 240 of the controller 210, the depression of the menu button 280, and the motion of the controller 210.

In the present embodiment, the selection of the character 4 is performed by the user moving the finger 21 in a mode that overviews the virtual space 1. However, the choice of the character 4 is not limited thereto, and any method can be employed if the character 4 is selected.

In addition, even in the mode (performance mode) in which the character 4 is operated, the user may select another character 4 during the operation of the character 4 and switch the character 4 to be operated. For example, the user may select the character 4 to be possessed by operation of the joystick 270 of the controller 210 or the menu button 280, or may determine that the character 4 disposed at the focal point of view in the single person view of the character 4 under operation is a character 4 to be possessed. In addition, during the operation of the character 4, the character 4 or the camera man 2 (camera 3) can be selected by using the hands or fingers of the character 4 to switch the possession. For example, a pointer having a shape such as a laser beam shape can be operated by the controller 210 to select the character 4 or the camera man 2 (camera 3) to be switched. After the selection of the switching object as described above, the actual switching may be performed in response to predetermined operation by the controller 210, or operation of the HMD 110 or the controller 210 to the detectable body portion of the user.

In addition, when the HMD 110 includes a line-of-sight detector for detecting a user's line of sight, the possessed object switching unit 480 determines the character 4 overlapping with the user's line of sight as a candidate for possession, and when the user's line of sight overlaps with the candidate character 4 for possession for a predetermined period or longer, the possessed object can be switched to the character 4. In addition, when the HMD 110 includes a point of view detecting unit for detecting a user's point of view, the possession target switching unit 480 determines a character 4 having overlapping viewpoints as a candidate for possession, and when the user's point of view overlaps with a candidate character 4 for possession for a predetermined period or longer, the possession target can be switched to the character 4. The point of view can be determined, for example, by determining the intersection of the lines of vision of both eyes of the user.

In addition, even in the mode in which the camera 3 is operated, the user may select the character 4 during the operation of the camera 3 and switch the character 4 to be operated. For example, the user may select a character 4 to be possessed by operation of the joystick 270 of the controller 210 or the menu button 280, or may determine a character 4 disposed at a focal point of view in the first person view of the camera man 2 during operation as a character 4 to be possessed. In addition, during the operation of the camera man 2, it is possible to select a character 4 or a camera man 2 (camera 3) to which the possession is switched using the hands or fingers of the camera man 2.

In the present embodiment, the second choice is whether the operation mode is a bird's-eye mode or not (S603). However, the rendering mode for creating the final animated image based on the action data may be provided.

In this embodiment, only one camera 3 is displayed, but a plurality of cameras 3 may be disposed in the virtual space 1. In this case, a switcher for turning off and returning the plurality of cameras 3 may be provided. The switcher may be, for example, a virtual device such as a button disposed within virtual space 1. The user can switch the camera 3 by operating the button. For example, a user may possess a character 4 to perform a performance, record the operation of the character 4, and reproduce the operation of the character 4, manipulate the camera 3, or take a photograph of the operation of the character 4 while switching the camera 3 in the birds-eye view mode. When the camera 3 is switched, the image included in the video that is ultimately generated is changed from the image of one camera 3 to the image of the other camera 3.

The switcher can be provided as a function unit for automatically switching the camera 3. In this case, the switcher can switch the camera 3 according to the music or rhythm played during a movie, such as a BGM, or switch the camera 3 according to a change in the color, light amount, or projection direction of the light disposed in the virtual space 1.

Further, when the plurality of cameras 3 are disposed in the virtual space 1, the settings may be changed for each camera. For example, the effect of color, smoothness, etc., to be applied to the image shot by the camera 3 can be changed for each camera 3. In addition, the light illumination direction by the light disposed in the virtual space 1 can be set for each camera 3, and the light can be controlled so that the light illumination direction is changed according to the change of the camera 3.

### EXPLANATION OF SYMBOLS

1 virtual space

2 cameraman

3 cameras

4 characters

110 HMD

120 display panel

130 housing

140 sensor

150 light source

210 controller

220 left hand controller

230 right hand controller

235 grip

240 trigger button

250 Infrared LED

260 sensor

270 joystick

280 menu button

300 Animation Production System

310 Image Generator

320 I/O portion

330 communication section

340 controller

350 storage

410 User Input Detector

420 character control unit

430 Image Generator

440 Camera Control

450 character data storage section

460 Program Storage

470 Image Data Storage

480 Charging object switching section

510 handle

520 display

530 rail

540 slider

550 recording button

1. An animation production system comprising:
a virtual camera located in a virtual space;
a user input detection unit that detects an input of a user from at least one of a head mounted display and a controller which the user mounts;
a character control unit that controls a character disposed in the virtual space in response to the input;
a gaze acquiring unit that acquires a gaze of the user; and
an operation target switching unit that switches the character to be operated by the user in accordance with the gaze.

2. The animation production system according to claim 1, wherein
the operation target switching unit switches the operation target to the character where the gaze overlaps for a predetermined period of time.

3. The animation production system according to claim 1, wherein
the gaze acquiring unit acquires the gazes of both eyes of the user,
the system further comprising a focus acquiring unit that determines a focus of the user based on the gazes, and
the operation target switching unit switches the operation target to the character where the focus overlaps for a predetermined period.
